(19) United States
(12) Patent Application Publication
(10) Pub. No.: US 2025/0222404 A1
(43) Pub. Date: Jul. 10, 2025

(54) Method and Apparatus for Performing a Primary and a Secondary Process

(71) Applicant: The University of Manchester, Manchester (GB)

(72) Inventors: Sebastian James Allender Leaper, Manchester (GB); Ahmed Abdelkarim, Manchester (GB)

(21) Appl. No.: 18/837,578

(22) PCT Filed: Feb. 10, 2023
(86) PCT No.: PCT/GB2023/050311

§ 371 Date: Aug. 9, 2024

(30) Foreign Application Priority Data
Feb. 11, 2022 (GB) 2201820.4
Feb. 11, 2022 (GB) 2201823.8
Mar. 1, 2022 (GB) 2202830.2

(51) Int. Cl. B01D 61/36; B01D 63/04

(52) U.S. Cl. CPC B01D 61/366; B01D 63/04; B01D 2313/22

(57) ABSTRACT

A method 30 and apparatus 31 for performing a primary and a secondary process using thermal energy of a body of water comprising a dissolved mineral. The method 30 comprising providing 40 high temperature water 34 from the body of water 33 and low temperature water 35 at from the body of water 33 to a primary apparatus 41, wherein the high temperature water 34 is at a first temperature which is higher than a second temperature of the low temperature water 35. Performing a primary process 50 in the primary apparatus 41, wherein the primary process comprises distilling the high temperature water 34 by membrane distillation to extract freshwater vapour from the high temperature water 34, wherein either the temperature difference between the high 34 and low 35 temperature water provides a temperature gradient to drive the membrane distillation or the low temperature water 35 is used to condense freshwater vapour. Removing the low temperature water 35 from the primary apparatus 60 and performing a secondary process 70 using the low temperature water 35.

This invention relates to a method and apparatus for performing a primary and secondary processes. In particular, the method and apparatus are configured to perform the primary and secondary processes using thermal energy of a body of water comprising a dissolved mineral

### BACKGROUND

Oceans, seas and bodies of water provide stores of thermal energy. The temperature, and therefore thermal energy, varies with the depth of water within the ocean, sea or body of water. Typically, water at lower depths is colder than water at the surface of the ocean, sea or body of water. Such thermal energy stores provide clean energy sources that are environmentally sustainable. The demand for providing energy from clean and sustainable sources is increasing due to higher electricity costs and increased concerns for global warming.

It is known to produce electricity through Ocean Thermal Energy Conversion (OTEC) processes by using the temperature difference between cold ocean water from the ocean depths and warm surface water. However, the thermal energy of oceans is not limited to use in the generation of electricity.

The present invention provides method and apparatus for performing a primary and secondary processes using thermal energy of a body of water.

### BRIEF SUMMARY OF THE DISCLOSURE

In accordance with an aspect of the present invention there is provided a method for performing a primary and secondary processes using thermal energy of a body of water comprising a dissolved mineral. The method comprises:
providing high temperature water from the body of water and low temperature water from the body of water to a primary apparatus to perform a primary process, wherein the high temperature water has a first temperature which is higher than a second temperature of the low temperature water,
performing a primary process in the primary apparatus, wherein the primary process comprises; distilling the high temperature water by membrane distillation in the distillation apparatus to extract freshwater vapour from the high temperature water, wherein either the temperature difference between the high and low temperature water provides a temperature gradient to drive the membrane distillation or the low temperature water is used to condense freshwater vapour;
removing the low temperature water from the primary apparatus and using the low temperature water to perform a secondary process.

In accordance with an aspect of the present invention there is provided a method for performing a primary and secondary processes using thermal energy of a body of water comprising a dissolved mineral. The method comprises:
providing high temperature water from the body of water and low temperature water from the body of water to a primary apparatus to perform a primary process, wherein the high temperature water has a first temperature which is higher than a second temperature of the low temperature water,
performing a primary process in the primary apparatus, wherein the primary process comprises; distilling the high temperature water by membrane distillation in the distillation apparatus to extract freshwater vapour from the high temperature water, wherein either the temperature difference between the high and low temperature water provides a temperature gradient to drive the membrane distillation or distillation or the low temperature water is used to condense freshwater vapour;
removing the high temperature water from the primary apparatus and using the high temperature water to perform a secondary process.

In accordance with another aspect of the present invention there is provided a method for performing a primary and a secondary process using thermal energy of a body of water comprising a dissolved mineral, the method comprising:
providing high temperature water from the body of water and low temperature water from the body of water to a primary apparatus, wherein the high temperature water is at a first temperature which is higher than a second temperature of the low temperature water;
performing a primary process in the primary apparatus, wherein the primary process comprises distilling the high temperature water by membrane distillation to extract freshwater vapour from the high temperature water, wherein either the temperature difference between the high and low temperature water provides a temperature gradient to drive the membrane distillation or the low temperature water is used to condense freshwater vapour;
removing the low temperature water from the primary apparatus and performing a secondary process using the low temperature water, wherein the secondary process comprises using the low temperature water in an air conditioning system.

The secondary process may comprise providing the low temperature water to a heat exchanger for cooling the air conditioning system.

The secondary process may comprise using the high temperature water in the air conditioning system.

The method may comprise removing the high temperature water from the primary apparatus and using the high temperature water in a tertiary process. The tertiary process may comprise aquaculture or cosmetics production. Additionally or alternatively, the method may comprise removing the low temperature water from the primary apparatus and using the low temperature water in the tertiary process.

The method may comprise removing the high temperature water from the primary apparatus and returning the high temperature water to the body of water.

In accordance with another aspect of the present invention there is provided a method for performing a primary and a secondary process using thermal energy of a body of water comprising a dissolved mineral, the method comprises:
providing high temperature water from the body of water and low temperature water from the body of water to a primary apparatus, wherein the high temperature water is at a first temperature which is higher than a second temperature of the low temperature water;
performing a primary process in the primary apparatus, wherein the primary process comprises distilling the high temperature water by membrane distillation to extract freshwater vapour from the high temperature water, wherein either the temperature difference between the high and low temperature water provides a temperature gradient to drive the membrane distillation or the low temperature water is used to condense freshwater vapour;
removing the low temperature water from the primary apparatus and performing a secondary process using the low temperature water, wherein the secondary process comprises using the low temperature water for carbon sequestering.

The step of carbon sequestering may comprise releasing the low temperature water at the surface of the body of water.

The step of carbon sequestering may comprise releasing the low temperature water below the surface of the body of water.

The step of carbon sequestering may comprise fertilising the low temperature water prior to releasing the low temperature water.

The step of carbon sequestering may comprise fertilising water at the surface of the body of water prior to releasing the low temperature water.

The method may comprise removing the high temperature water from the primary apparatus; wherein the secondary process may comprise using a mixture of the low temperature and high temperature water for carbon sequestering; and wherein the step of carbon sequestering may comprise fertilising the mixture of the low temperature and high temperature water prior to releasing the mixture at the surface of the body of water.

The step of fertilising may comprise adding soluble iron, phosphorus, nitrogen and/or silicon. The step of fertilising may comprise adding wastewater or mineral olivine.

Embodiments of the method according to any one of the above-described aspects of the invention may comprise any of the following.

The method may comprise removing the freshwater from the primary apparatus.

The low temperature water may have a temperature from 4 to 25° C. and/or the high temperature water may have a temperature from 10 to 80° C. The low temperature water may have a temperature from 4 to 14° C. and/or the high temperature water may have a temperature from 25 to 30° C. The low temperature water have may a temperature of approximately 10° C. and the high temperature water may have a temperature of approximately 30° C.

In certain embodiments, the step of distilling the high temperature water by membrane distillation may comprise providing a membrane distillation apparatus comprising:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which freshwater vapour is passable such that, during use, a permeate of freshwater vapour is separable from a fluid that is within one of the at least one second fluid passageway and the plurality of third fluid passageways; and
distilling the high temperature water using the membrane distillation apparatus.

In certain embodiments, the step of distilling the high temperature water may comprise:
feeding the high temperature water through the plurality of third fluid passageways;
extracting the freshwater vapour from the at least one second fluid passageway; and
feeding the low temperature water through the first fluid passageway.

In certain embodiments, the step of distilling the high temperature water comprises: feeding the high temperature water through the at least one second fluid passageway;
feeding a freshwater coolant having a lower temperature than the high temperature water through the plurality of third fluid passageways; and
extracting the freshwater vapour and freshwater coolant from the plurality of third fluid passageways;
wherein the freshwater coolant is cooled by the low temperature water via a heat exchanger.

In certain embodiments, the step of distilling the high temperature water in the primary apparatus may comprise:
providing a membrane distillation apparatus comprising a membrane, wherein the membrane comprises a hydrophobic material through which the freshwater vapour is passable,
providing the high temperature water to a first side of the membrane;
providing the low temperature water on a second side of the membrane, wherein the low temperature water is enclosed within a heat exchanger.

In accordance with another aspect of the invention there is provided an apparatus for performing a primary and secondary processes using thermal energy of a body of water 15 comprising a dissolved mineral. The apparatus comprises:
a primary apparatus configured to receive high temperature water from the body of water and low temperature water from the body of water and perform a primary process, the primary apparatus comprising a membrane distillation apparatus for distilling the high temperature water to provide freshwater vapour, wherein the high temperature water has a first temperature which is higher than a second temperature of the low temperature water and the primary apparatus is configured such that either the temperature difference between the high and low temperature water provides a temperature gradient to drive the membrane distillation or the low temperature water is used to condense freshwater vapour; and
means for removing the low temperature water from the distillation apparatus and means for conveying the low temperature water to an apparatus for a secondary process.

In accordance with another aspect of the invention there is provided an apparatus for performing a primary and secondary processes using thermal energy of a body of water comprising a dissolved mineral. The apparatus comprises:
a primary apparatus configured to receive high temperature water from the body of water and low temperature water from the body of water and perform a primary process, the primary apparatus comprising a membrane distillation apparatus for distilling the high temperature water to provide freshwater vapour, wherein the high temperature water has a first temperature which is higher than a second temperature of the low temperature water and the primary apparatus is configured such that either the temperature difference between the high and low temperature water provides a temperature gradient to drive the membrane distillation or the low temperature water is used to condense freshwater vapour; and
means for removing the high temperature water from the distillation apparatus and means for conveying the high temperature water to an apparatus for a secondary process.

In accordance with another aspect of the invention there is provided an apparatus for performing a primary and a secondary process using thermal energy of a body of water comprising a dissolved mineral. The apparatus comprises:
a primary apparatus configured to receive high temperature water from the body of water and low temperature water from the body of water and perform a primary process, the primary apparatus comprising a membrane distillation apparatus for distilling the high temperature water to provide freshwater vapour, wherein the high temperature water has a first temperature which is higher than a second temperature of the lower temperature water and the primary apparatus is configured such that either the temperature difference between the high and low temperature water provides a temperature gradient to drive the membrane distillation or the low temperature water is used to condense freshwater vapour; and
means for removing the low temperature water from the membrane distillation apparatus and for conveying the low temperature water to a secondary apparatus for performing a secondary process, wherein the secondary apparatus is an air conditioning system configured to be cooled by the low temperature water.

The air conditioning system may comprise a heat exchanger configured to receive the low temperature water.

The apparatus may comprise means for removing the high temperature water from the primary apparatus and one of means for returning the high temperature water to the body of water, or means for conveying the high temperature water to a tertiary apparatus for a tertiary process. Additionally or alternatively, the apparatus may comprise means for removing the low temperature water from the primary apparatus and means for conveying the low temperature water to a tertiary apparatus for a tertiary process

The apparatus may comprise means for removing the high temperature water from the primary apparatus and conveying the high temperature water to the secondary apparatus, wherein the air conditioning system is configured to use the high temperature water.

In accordance with another aspect of the invention there is provided an apparatus for performing a primary and secondary processes using thermal energy of a body of water comprising a dissolved mineral. The apparatus comprises:
a primary apparatus configured to receive high temperature water from the body of water and low temperature water from the body of water and perform a primary process, the primary apparatus comprising a membrane distillation apparatus for distilling the high temperature water to provide freshwater vapour, wherein the high temperature water has a first temperature which is higher than the a second temperature of the lower temperature water and the primary apparatus is configured such that either the temperature difference between the high and low temperature water provides a temperature gradient to drive the membrane distillation or the low temperature water is used to condense freshwater vapour;
means for removing the low temperature water from the membrane distillation apparatus and means for using the low temperature water in a secondary process of carbon sequestering.

The apparatus may comprise means for releasing the low temperature water at the surface of the body of water for carbon sequestering.

The apparatus may comprise means for fertilising the low temperature water prior to releasing the low temperature water.

The apparatus may comprise means for removing the high temperature water from the primary apparatus, means for mixing the low temperature and high temperature water and using said mixture for carbon sequestering, and means for fertilising the mixture prior to releasing the mixture at the surface of the body of water.

Embodiments of the apparatus according to any one of the above-described aspects of the invention may comprise any of the following.

The apparatus may comprise means for removing the freshwater from the primary apparatus.

In certain embodiments, the membrane distillation apparatus may comprise:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which freshwater vapour is passable such that, during use, a permeate of freshwater vapour is separable from a fluid that is within one of the at least one second fluid passageway and the plurality of third fluid passageways

The at least one inner conduit comprises a plurality of inner conduits.

The apparatus may comprise a potting material configured to fixedly position the plurality of hollow fibre membranes within the at least one inner conduit.

The outer conduit and/or the inner conduit comprises an impermeable material.

The at least one the inner conduit comprises a thermally conductive material.

In certain embodiments, the apparatus may comprise: a first collar securable to an end of the outer conduit; a first insert releasably securable to the first collar; and a plurality of first o-rings arranged between the first collar and the first insert, wherein each of the first collar and the first insert comprise a plurality of apertures and the plurality of inner conduits extend through the first collar and the first insert via the apertures; wherein one of the first o-rings surrounds each of the inner conduits; and wherein the first insert is securable to the first collar such that each of the first o-rings are compressed to sealing engage one of the inner conduits.

One of the first collar and the first insert may comprise a groove extending circumferentially around each aperture, the grooves being configured to receive the first o-rings between the first collar and the first insert; and wherein the height of the first o-rings is greater than the height of the grooves.

Each of the first collar and the first insert may comprise a groove extending circumferentially around each aperture, the grooves being configured to receive the first o-rings between the first collar and the first insert; and wherein the height of the first o-rings is greater than the combined height of the grooves in the first insert and the first collar.

The first insert may be releasably securable to the first collar by at least one threaded fastener. The first insert may be releasably securable to the first collar by a plurality of threaded fasteners.

The first collar may be releasably securable to the outer conduit. The first collar may be releasably securable to the outer conduit by at least one threaded fastener. The first collar may be releasably securable to the outer conduit by a plurality of threaded fasteners.

In certain embodiments, each of the plurality of inner conduits may comprises a bundle of hollow fibre membranes disposed therein and each bundle comprises a support configured to secure the hollow fibre membranes together.

The support may be configured to fixedly position the plurality of hollow fibre membranes relative to one another.

The support may comprise a potting material.

In certain embodiments, the apparatus may comprise: a second collar securable to the first collar; a second insert releasably securable to the second collar; and a plurality of second o-rings arranged between the second collar and the second insert; wherein each of the second collar and the second insert comprise a plurality of apertures, each aperture being configured to receive one of the supports so that the plurality of hollow fibre membranes extend through the second collar and the second insert; wherein one of the second o-rings surrounds each of the supports; and wherein the second insert is securable to the second collar such that each of the second o-rings are compressed to sealing engage one of the supports.

One of the second collar and the second insert may comprise a groove extending circumferentially around each aperture, the grooves being configured to receive the second o-rings between the second collar and the second insert; and wherein the height of the second o-rings is greater than the height of the grooves.

Each of the second collar and the second insert may comprise a groove extending circumferentially around each aperture, the grooves being configured to receive the second o-rings between the second collar and the second insert; and wherein the height of the second o-rings is greater than the combined height of the grooves in the second insert and the second collar.

The second insert may be releasably securable to the second collar by at least one threaded fastener. The second insert may be releasably securable to the second collar by a plurality of threaded fasteners.

The second collar may be releasably securable to the first collar. The second collar may be releasably securable to first collar by at least one threaded fastener. The second collar may be releasably securable to first collar by a plurality of threaded fasteners.

In certain embodiments, the apparatus may comprise a cap releasably securable to the second collar.

In certain embodiments, the first collar may comprise an opening configured to allow fluid to enter or exit the second fluid passageways.

In certain embodiments, the cap may comprise an opening configured to allow fluid to enter or exit the third fluid passageways.

In certain embodiments, the outer conduit may comprise at least one opening configured to allow fluid to enter or exit the first fluid passageway.

In certain embodiments, the membrane distillation apparatus may comprise:
a membrane comprising a hydrophobic material through which the freshwater vapour is passable,
the apparatus is configured to receive the high temperature water at a first side of the membrane;
the apparatus comprises a heat exchanger on a second side of the membrane, wherein the heat exchanger is configured to receive the low temperature water.

### BRIEF DESCRIPTION OF THE DRAWINGS

Embodiments of the invention are further described hereinafter with reference to the accompanying drawings, in which:

FIG. 1 shows a method according to an embodiment of the invention;

FIG. 2 schematically shows an apparatus according to an embodiment of the invention;

FIG. 3 schematically shows an apparatus according to an embodiment of the invention;

FIG. 4 schematically shows a sectional side-view of a membrane distillation apparatus according to an embodiment of the present invention;

FIG. 5 schematically shows a cross-section of the membrane distillation of FIG. 4;

FIG. 6 schematically shows a cross-section of a part of the membrane distillation of FIG. 4;

FIG. 7 schematically shows a membrane distillation apparatus according to an embodiment of the present invention; and

FIGS. 8 and 9 schematically shows a membrane distillation apparatus according to an embodiment of the present invention.

### DETAILED DESCRIPTION

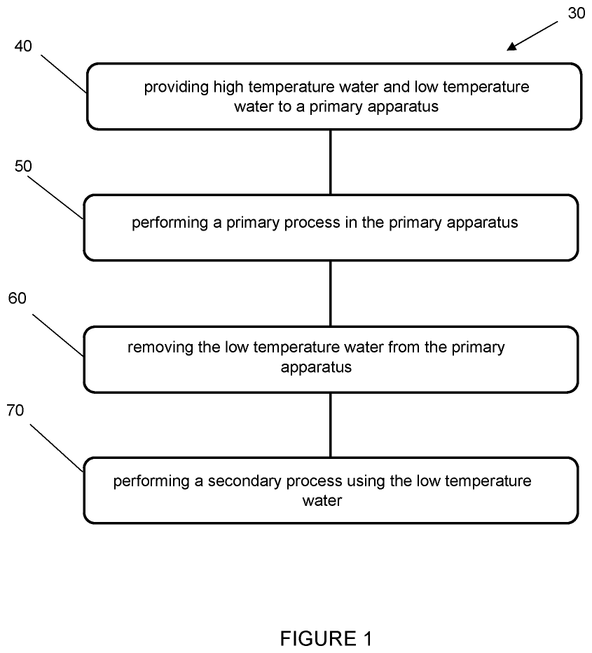

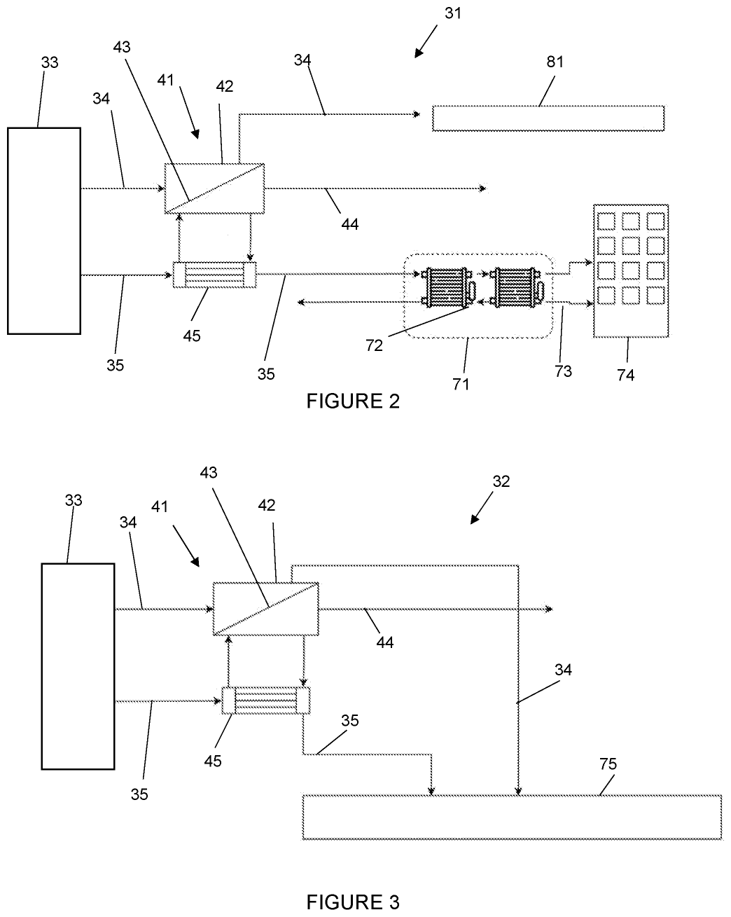

According to an embodiment of the invention, FIG. 1 shows a method 30 for performing a primary and a secondary process using thermal energy of a body of water 33 comprising a dissolved mineral. FIGS. 2 and 3 each show an apparatus 31, 32 which is suitable for performing a primary and a secondary process using thermal energy of the body of water 33.

The body of water 33 may comprise any body of water 33 in which the temperature of the water varies with depth. That is, water at the surface of the body has a higher temperature than water below the surface of the body. The temperature gradient across different depths of the body of water 33 provides the thermal energy for performing the primary and secondary processes. Non-limiting examples of suitable bodies of water include oceans, seas and salt-water lakes. In such examples, the dissolved mineral may comprise any of a plurality of dissolved minerals found in oceans, seas and salt-water. For example, the dissolved mineral may comprise a salt such as sodium chloride.

As shown in FIG. 1, the method 30 comprising providing 40 high temperature water 34 from the body of water 33 and low temperature water 35 from the body of water 33 to a primary apparatus 41. As shown in FIGS. 2 and 3, each apparatus 31, 32 comprises a primary apparatus 41 which is configured to receive the high temperature water 34 and the low temperature water 35. Depending on the body of water 33, non-limiting examples of the high and low temperature water are brine and saline water.

The high temperature water 34 is at a first temperature which is higher than a second temperature of the low temperature water 35. Thus, the high temperature water 34 may be sourced from at or towards the surface of the body of water 33 and the low temperature water 35 may be sourced from a lower depth than the high temperature water 34. The first temperature of the high temperature water 34 may be from 10 to 80° C. The second temperature of the low temperature water 35 may be from 4 to 25° C. In certain embodiments, the high temperature water 34 and low temperature water 35 may be provided to the primary apparatus 41 directly from a sea. The high temperature water 34 may be sourced from the surface of the sea. The low temperature water 35 may be source from at least 500 m below sea level. In such embodiments, the first temperature may be from 25 to 30° C. and the second temperature may be from 4 to 14° C. For example, first temperature may be approximately 30° C. and the second temperature may be approximately 10° C.

In certain embodiments, the step of providing 40 high temperature water 34 from the body of water 33 to the primary apparatus 41 may comprise heating water from the body of water 33 to provide the high temperature water 34. Thus, the water may reach a higher temperature than the naturally occurring temperature of the body of water 33. For example, water from the body of water 33 may be heated so that the first temperature of the high temperature water 34 is from 30 to 80° C. The water may be heated using any suitable heating means. For example, water from the body of water 33 may be heated by solar heating. In such embodiments, the apparatus 31, 32 may be modified to comprise any suitable heating means (not shown) configured to heat water from the body of water 33. The heating means may be arranged between the body of water 33 and the primary apparatus 41.

Once the high 34 and low 35 temperature water has been received by the primary apparatus 41, the method 30 comprises performing 50 a primary process in the primary apparatus 41. The primary process may use the thermal gradient created in the primary apparatus 41 by the temperature difference between the high temperature water 34 and the low temperature water 35.

Once the primary process has been performed, the method comprises removing 60 the low temperature water from the primary apparatus 41 and performing 71 a secondary process using the low temperature water 35. As such, the apparatus 31, 32 may comprise means for removing the low temperature water 35 from the primary apparatus 31, 31. The apparatus 31, 32 may comprise means for conveying the low temperature water 35 to a secondary apparatus 71 and/or means for using the low temperature water 35 in the secondary process. The secondary process may comprise the air conditioning, carbon sequestering, aquaculture, cosmetics production, electricity generation via a Rankine cycle or other processes.

In certain embodiments, the high temperature water 34 may be removed from the primary apparatus 41 once the primary process has been performed for use in the secondary process. Thus, the apparatus 31, 32 may comprise means for removing the high temperature water 34 from the primary apparatus 41 and conveying the high temperature water to the secondary apparatus 71 and/or means for using the high temperature water 34 in the secondary process. Alternatively, the high temperature water 34 may be removed from the primary apparatus 41 for use in a tertiary process or the high temperature water 34 may be removed from the primary apparatus and returned to the body of water 33. In such embodiments, the apparatus 31, 32 may comprise means for removing the high temperature water 34 from the primary apparatus 41 and one of means for returning the high temperature water 34 to the body of water 33 or means for conveying the high temperature water 34 to a tertiary apparatus 81 for use in the tertiary process. Non-limiting examples of tertiary processes include aquaculture or cosmetics production.

In certain embodiments, the low temperature water 35 may be removed from the primary apparatus 41 for use in the tertiary process. This may be in addition to or as an alternative to using the high temperature water 34 in the tertiary processes. In such embodiments, the apparatus may comprise means for conveying the low temperature water 35 to a tertiary apparatus 81 for use in the tertiary process.

In the method, the primary process comprises distilling the high temperature water 34 by membrane distillation to extract freshwater vapour from the high temperature water 34. The primary apparatus 41 in each of the embodiments of FIGS. 2 and 3 comprises a membrane distillation apparatus 42. The membrane distillation apparatus 42 is configured to receive the high temperature water 34. The membrane distillation apparatus 42 is the same in both of the embodiments shown in FIGS. 2 and 3. The step of distilling the high temperature water 34 by membrane distillation may comprise providing the membrane distillation apparatus 42.

The membrane distillation apparatus 42 comprises a hydrophobic membrane or material 43 through which water vapour can pass down a vapour pressure gradient. However, liquid water and non-volatile minerals, such as sodium chloride, are unable to pass through the membrane 43. In the method of the embodiment shown in FIG. 1, the vapour pressure gradient is created by the different temperatures of the high temperature water 34 and low temperature water 35. The temperature difference between the high temperature water 34 and low temperature water 35 may provide a temperature gradient which drives the membrane distillation. In alternative embodiments, the vapour pressure gradient maybe provided by suitable alternative means. In such embodiments, the low temperature water 3 is used to condense freshwater vapour which is extracted from the high temperature water 34.

To distil the high temperature water 34, the high temperature water 34 contacts a first side of the hydrophobic membrane 43 and freshwater vapour permeates through the membrane 43 to a second side of the membrane 43. The hydrophobic membrane 43 comprises a plurality of pores through which the freshwater vapour passes. The freshwater vapour may then be collected and condensed into freshwater 44. The freshwater 44 may be removed from the primary apparatus 41. Thus, the apparatus 31, 32 may comprise means for removing the freshwater 44 from the primary apparatus 41.

The low temperature water 35 is provided on the second side of the membrane 43. The low temperature water 35 creates the temperature gradient from the first side to the second side of the membrane 43 which may drive the membrane distillation. The low temperature water 35 is enclosed within a heat exchanger 45 on the second side of the membrane 43. Thus, the low temperature water does not directly contact the freshwater vapour thereby avoiding contamination of the freshwater vapour by the low temperature water 35. The freshwater vapour may condense on the heat exchanger 45. As shown in FIGS. 2 and 3, the primary apparatus 41 comprises a heat exchanger 45 on the second side of the membrane 43. The heat exchanger 45 is configured to receive the low temperature water 35.

The membrane distillation apparatus 42 may be configured such that high temperature water 34 undergoes one of direct contact membrane distillation (DCMD), air gap membrane distillation (AGMD), sweep gas membrane distillation (SGMD), vacuum membrane distillation (VMD), vacuum-assisted air gap membrane distillation (VA-AGMD), liquid gap membrane distillation (LGMD) or material gap membrane distillation (MGMD). The membrane 44 in the membrane distillation apparatus 42 may be in the form of flat sheets, spiral wound, tubular, or hollow fibre modules.

In embodiments where vacuum membrane distillation is used, the vapour pressure gradient is provided by a vacuum on the second side of the membrane 43. In such embodiments, the low temperature water 35 is used to condense the freshwater vapour.

Distilling the high temperature water by membrane distillation enables desalinated water vapour to be collected. This vapour may be condensed and used as a freshwater source. Membrane distillation may enable water with a higher purity to be produced at lower energy costs compared to typical of conventional pressure-driven membrane processes such as reverse osmosis.

The expected percentage of freshwater 44 produced relative to the high temperature water 34 used in the method is of the order of 0.5-3%. The recovery of freshwater 44, when the membrane distillation is driven by the temperature gradient across the membrane 43, is limited by the temperature difference between the high temperature water 34 and low temperature water 35. If the high and low temperature waters 34, 35 are taken directly from the body of water 33 (i.e. the high temperature water 34 is not provided by heating water from the body of water 33), the temperature difference may be approximately 20° C. In such embodiments, the method may require large input flow rates of the high temperature water 34 to generate significant quantities of freshwater 44. If the recovery percentage of freshwater is 1%, the method may be used to produce 10,000 m³ per day of freshwater 44 from a feed flow rate of 1000,000 m³ per day of high temperature water 34. The membrane flux may be in the range of 0.1-10 Lm⁻²h⁻¹. If the flux is 1 Lm⁻²h⁻¹, the area of the membrane 43 in the membrane distillation apparatus 42 may be from 410,000 m² to 420,000 m². The recovery of freshwater 44 may be increased by increasing the temperature difference between the high temperature water 34 and the low temperature water 35.

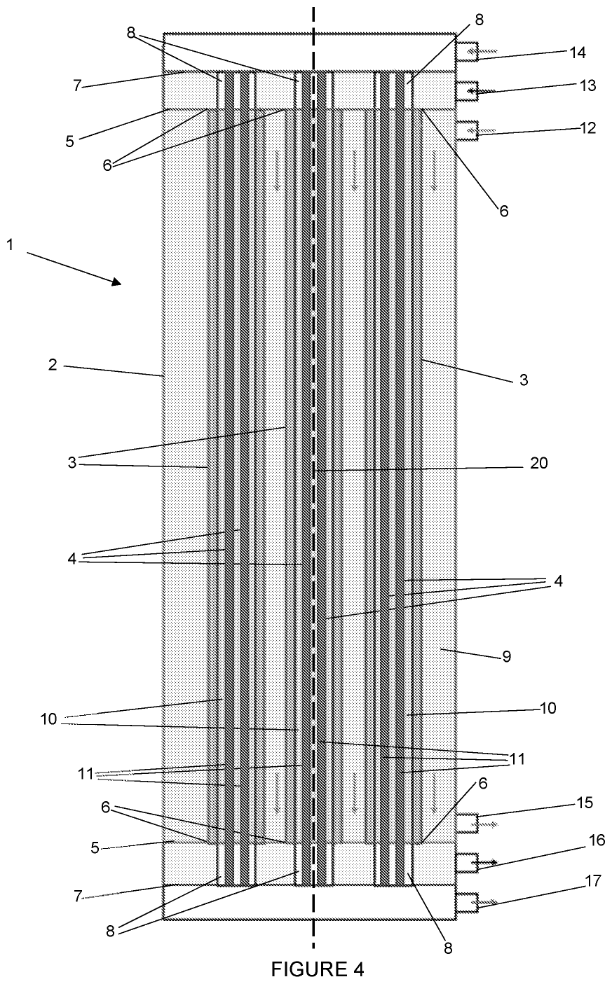

The primary apparatus 41 is not limited to the membrane distillation apparatus 42 and heat exchanger 45 shown in FIGS. 2 and 3. In alternative embodiments, the method step of distilling the high temperature water 34 by membrane distillation may comprise providing any suitable alternative membrane distillation apparatus, including but not limited to a membrane distillation apparatus according to the embodiments shown in FIGS. 4 to 7. The primary apparatus 41 of the embodiments shown in FIGS. 2 and 3 may be modified to comprise the membrane distillation apparatus of the embodiments shown in FIGS. 4 to 7.

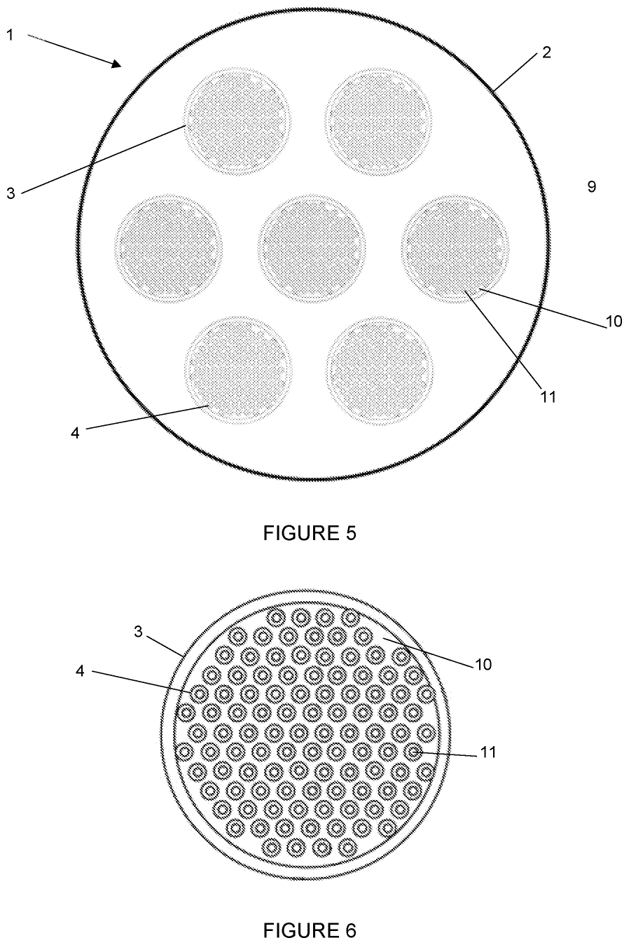

FIGS. 4 and 5 show an embodiment of a membrane distillation apparatus 1. The membrane distillation apparatus 1 comprises an outer conduit 2. The outer conduit 2 is elongate in shape and has a longitudinal axis 20. In the embodiment shown in FIGS. 4 and 5, the outer conduit 2 is tubular i.e. the outer conduit 2 has a circular cross-section. However, in alternative embodiments, the cross-section of the outer conduit 2 may have a different shape. For example, the cross-section may be hexagonal or rectangular.

The outer conduit 2 may comprise an impermeable material. That is, a material through which fluid cannot pass. Non-limiting examples of suitable impermeable materials include acrylonitrile butadiene styrene (ABS), polypropylene, polyvinyl chloride (PVC), stainless steel and other metallic materials.

Within the outer conduit 2, the membrane distillation apparatus 1 comprises at least one inner conduit 3. The inner conduit 3 extends substantially along the length of the outer conduit 2. In the non-limiting embodiment shown in the FIGS. 4 and 5, the membrane distillation apparatus 1 comprises a plurality of inner conduits 3, namely, seven inner conduits 3. However, in alternative embodiments the membrane distillation apparatus 1 may comprise a different number of inner conduits 3. As shown in FIG. 5, the plurality of inner conduits 3 may be uniformly distributed within the outer conduit 2.

Each of the inner conduits 3 of FIGS. 4 and 5 is elongate in shape. A longitudinal axis (not shown) of each inner conduit 3 is parallel to the longitudinal axis 20 of the outer conduit 2. As such, the outer conduit 2 and the plurality of inner conduits 3 are parallel to one another.

As shown in FIGS. 5 and 6, the plurality of inner conduits 3 are tubular (i.e. the inner conduits 3 have a circular cross-section). The diameters of all of the inner conduits 3 in the apparatus may be the same as one another. However, in alternative embodiments, the cross-section of the inner conduits may have different shapes and/or may have a range of different sizes. For example, the cross-section may be hexagonal or rectangular and the diameters of the inner conduits may differ from one another.

Each inner conduit 3 may comprise an impermeable material. Each inner conduit 3 may comprise a thermally conductive material. For example, each inner conduit 3 may comprise a graphite-polymer composite. The graphite of each inner conduit 3 may be radially aligned relative to the longitudinal axis of the inner conduit 3 to improve its thermal conductivity. The polymer is included in the composite to reduce the risk of corrosion of the inner conduit 3 during use. Additionally, the polymer may improve the ease of washing off of any crystals that are formed on the inner conduit 3 during use. The polymer used in the composite may depend on the temperatures associated with the intended use of the apparatus. For example, the polymer may comprise polyvinyl chloride (PVC) when the temperature in the apparatus will not exceed 60° C. during use. Alternatively, the polymer may comprise polypropylene or polyphenylene sulphide (PPS) when the temperature in the apparatus will exceed 60° C. during use.

Within each of the inner conduits 3, the membrane distillation apparatus 1 comprises a plurality of hollow fibre membranes 4. Thus, a bundle of hollow fibre membranes 4 is within each inner conduit 3. As shown in the embodiment of FIGS. 4 to 6, each of the inner conduits 3 may contain the same number of hollow fibre membranes 4. The plurality of hollow fibre membranes 4 may be uniformly distributed within each inner conduit 3.

As shown in the embodiment in FIGS. 4 to 6, each of plurality of hollow fibre membranes 4 may be tubular in shape. The diameters of all of the hollow fibre membranes 4 in the membrane distillation apparatus 1 may be the same as each other. Each hollow fibre membrane 4 has a longitudinal axis which is substantially parallel to the longitudinal axis 20 of the outer conduit 2. As such, the outer conduit 2, the plurality of inner conduits 3 and the plurality of hollow fibre membranes 4 are substantially parallel with one another. In the embodiment shown in FIGS. 4 and 5, each of the plurality of hollow fibre membranes 4 extends at least along the length of the outer conduit 2 and the plurality of inner conduits 3.

The plurality of hollow fibre membranes 4 comprise a hydrophobic material through which freshwater vapour is passable during use. As such, freshwater vapour may pass into or out of the hollow fibre membranes 4 during use. The hydrophobic material comprises a plurality of pores through which the vapour passes.

At each end, the membrane distillation apparatus 1 comprises a first cap 5 configured to fluidly seal the outer conduit 2. The first cap 5 may be welded to the outer conduit 2 to provide a fluid tight seal.

The first cap 5 comprises a plurality of apertures 6. Through each aperture 6, one of plurality of inner conduits 3 extends. Each inner conduit 3 may be welded to its corresponding aperture 6 in the first cap 5 to provide a fluid tight seal.

As shown in FIG. 4, at each end the membrane distillation apparatus 1 also comprises a second cap 7 configured to fluidly seal the plurality of inner conduits 3. The second cap 7 may be welded to the plurality of inner conduits to provide a fluid tight seal. The plurality of hollow fibre membranes 4 extend through at least part of the second cap 7. As shown in the embodiment to FIG. 4, the second cap 7 may also be configured to fluidly seal the plurality of hollow fibre membranes 4. In alternative embodiments, the plurality of hollow fibre membranes 4 may be fluidly sealed by another suitable means. For example, the bundle of hollow fibre membranes 4 in each inner conduit 3 may be fluidly sealed by a separate cap.

As shown in FIG. 4, the plurality of hollow fibre membranes 4 within each inner conduit 3 may be held in a fixed position relative the inner conduit 3 in the second cap 7. The membrane distillation apparatus 1 comprises a potting material 8 to hold each of the plurality of hollow fibre membranes 4 in position. The potting material 8 may comprise a solid cylinder having a plurality of apertures (not shown) through which the plurality of hollow fibre membranes 4 extend. Each of the hollow fibre membranes 5 may be fixed to the plurality of apertures in the solid cylinder with additional potting material 8. As such, the hollow fibre membranes 4 may be held in a fixed position relative to the plurality of inner conduits 3 at either end of the membrane distillation apparatus 1. The potting material 8 may comprise any suitable material for fixing the plurality of hollow fibre membranes 4 in place. Suitable potting materials include but are not limited to epoxy, polyurethane and silicone adhesives.

The arrangement of the outer conduit 2, the at least one inner conduit 3 and the plurality of hollow fibre membranes 5 provides fluid passageways through the apparatus.

A first fluid passageway 9 is provided between the outer conduit 2 and the at least one inner conduit 3. As such, in the embodiment shown in FIGS. 4 and 5, fluid can flow in the volume between the outside of the plurality of inner conduits 3 and the inside of the outer conduit 2 during use.

The membrane distillation apparatus 1 also comprises at least one second fluid passageway 10. Each second fluid passageway 10 is provided between one of the inner conduits 3 and the plurality of hollow fibre membranes 4 within that conduit 3. As such, during use fluid can flow in the volume between the outside of the plurality of hollow fibre membranes 4 and the inside of the inner conduit 3 within which the hollow fibre membranes 4 are located. In the embodiment shown in FIGS. 4 and 5, the membrane distillation apparatus 1 comprises a plurality of second fluid passageways 10 as the apparatus comprises a plurality of inner conduits 3. In embodiments where the apparatus comprises only one inner conduit 3, the membrane distillation apparatus 1 provides a single second fluid passageway 10.

A plurality of third fluid passageways 11 is provided in the membrane distillation apparatus 1. One of the plurality of third fluid passageways 11 is provided within each of the plurality of hollow fibre membranes 4 of the membrane distillation apparatus 1. As such, during use fluid can flow through the plurality of hollow fibre membranes 4.

In the membrane distillation apparatus 1, the hydrophobic material of the plurality of hollow fibre membranes 4 provides the boundary between the second fluid passageway 10 and the third fluid passageways 11 within that second fluid passageway 10. Therefore, during use of the membrane distillation apparatus 1, freshwater vapour is able to pass between the second fluid passageways 10 and the third fluid passageways 11. Thus, the apparatus can be used to separate a vaporous permeate (i.e. freshwater vapour) from a fluid that is within one of the at least one second fluid passageway 10 and the plurality of third fluid passageways 11. Several examples of different uses of the membrane distillation apparatus 1 are described below and may be used in the method of the embodiment shown in FIG. 1.

The membrane distillation apparatus 1 comprises a plurality of inlets 12, 13, 14 and outlets 15, 16, 17 for the fluid passageways 9, 10, 11 configured to permit fluid to enter and exit the respective fluid passageways. The membrane distillation apparatus 1 comprises inlets 12, 13, 14 for the first 9, second 10 and third 11 fluid passageways, respectively, at one end of the membrane distillation apparatus 1 and outlets 15, 16, 17 for the first 9, second 10 and third 11 fluid passageways, respectively, at the other end of the membrane distillation apparatus 1. As shown in FIG. 4, the inlet 12 and the outlet 15 for the first fluid passageway 9 are formed in the outer conduit 2. The inlet 13 and the outlet 16 of the plurality of second fluid passageways 10 and the inlet 14 and the outlet 17 of the plurality of third fluid passageways 11 are formed in the second cap 7.

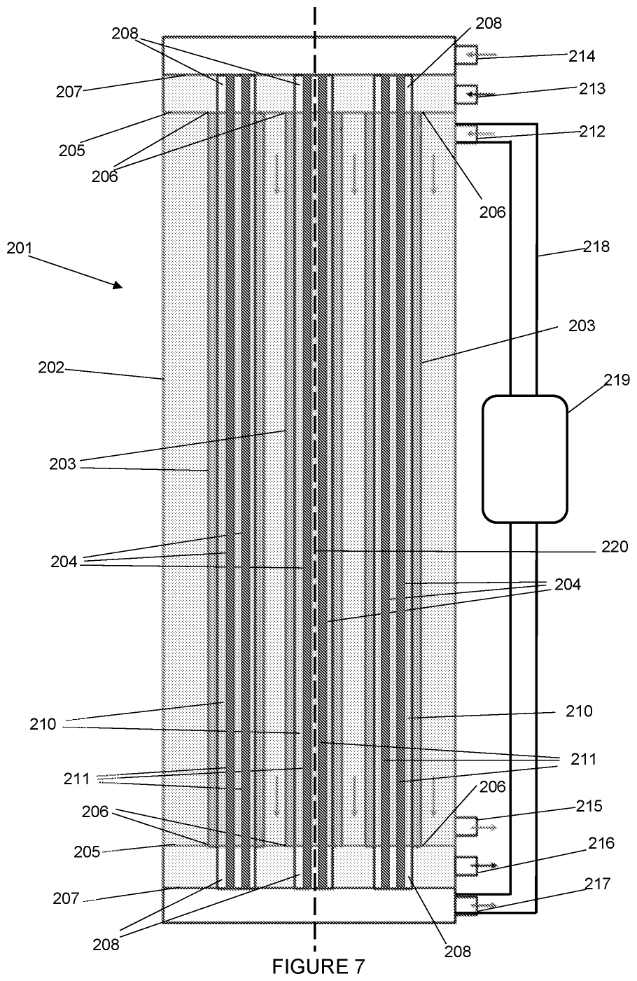

FIG. 7 shows a membrane distillation apparatus 201 according to another embodiment of the invention. The membrane distillation apparatus 201 is identical to the membrane distillation apparatus 1 of FIGS. 4 to 6 except that the membrane distillation apparatus 201 of FIG. 7 comprises an additional fluid passageway. Reference numerals in FIG. 7 correspond to those used in FIGS. 4 to 6 for like features but are transposed by 200.

The membrane distillation apparatus 201 comprises a common fluid passageway 218. As shown in FIG. 7, the outlet 217 of each the plurality of third fluid passageways 211 is fluidly connected to the inlet 212 of the first fluid passageway 209 via the common fluid passageway 218. As such, fluid exiting the plurality of third fluid passageways 211 may enter the first fluid passageway 209 and be recirculated through the membrane distillation apparatus 201.

The common fluid passageway 218 may comprise recirculation means 219 for driving the recirculation fluid from the plurality of third fluid passageways 211 into the first fluid passageway 209 and for increasing the temperature and pressure of the fluid. The recirculation means 219 may comprise a vacuum pump, a fan or a compressor.

The apparatus of FIGS. 4 to 7 may be used in the following two methods to distil the high temperature water 34. Each method may be used when performing the primary process 50 in the method of the embodiment shown in FIG. 1. The arrows shown in FIGS. 4, 5 and 7 illustrate the direction of fluid flow within each apparatus during the different methods.

A first method for distilling the high temperature water 34 may comprise providing a membrane distillation apparatus 1 according to the embodiments shown in FIGS. 3 and 4 and feeding a high temperature water 34 through the plurality of third fluid passageways 11. Feeding the high temperature water 34 through the plurality of third fluid passageways 11 may comprise feeding the high temperature water 34 at a pressure that is less than the liquid entry pressure of the hydrophobic material of the plurality of the hollow fibre membranes 4. The liquid entry pressure for the hollow fibre membranes 4 is the pressure threshold which, when exceeded, the hydrophobic properties of the hollow fibre membranes 4 are overcome. The liquid entry pressure may vary with the pore sizes of the hollow fibre membranes 4, the number of hollow fibre membranes 1 within each inner conduit 3 and the diameters of the hollow fibre membranes 4. In certain embodiments, the liquid entry pressure may be between 1 bar and 4 bar.

During the first method, the vapour pressure in the plurality of third fluid passageways 11 is greater than the vapour pressure in the plurality of second fluid passageways 10 of the apparatuses 1 of FIGS. 4 and 5. As discussed above, this difference in vapor pressure drives a vaporous permeate (i.e. fresh water vapour) of the high temperature water 34 through the hydrophobic material of the plurality of hollow fibre membranes 4 into the plurality of second fluid passageways 10. The permeate is therefore separated from the high temperature water 34 by membrane distillation. In embodiments of the invention, the vaporous permeate is freshwater vapour. The difference in vapour pressure between the plurality of third fluid passageways 11 and the plurality of second fluid passageways 10, 110 may be created at least in part by a temperature gradient.

Once the permeate enters the plurality of second fluid passageways 10, it is subsequently extracted from the plurality of second fluid passageways 10. The permeate is extracted through the outlet 16 of the plurality of second fluid passageways 10.

The first method comprises feeding the low temperature water 35 through the first fluid passageway 9. Since the low temperature water 35 has a lower temperature than the high temperature water 34, the low temperature water 35 provides a temperature gradient from the plurality of third passageways 11 to the first passageway 9, 109 which drives the permeate into the plurality of second fluid passageways 10. The low temperature water 35 may also enable at least part of the permeate of the high temperature water 34 to condense in the plurality of second fluid passageways 10. The permeate may condense on the plurality of inner conduits 3. Since the low temperature water 35 is used as a coolant within the membrane distillation apparatus 1, there is no need to provide a heat exchanger when the first method is used with the membrane distillation apparatus 1 of FIG. 4.

As the high temperature water 34 passes through the plurality of third fluid passageways 11 the high temperature water 34 is cooled due to heat losses from evaporation of the permeate and through conduction. When the high temperature water 34 exits the plurality of third passageways it may have cooled sufficiently to be used the coolant. This may occur in embodiments where the step of providing 40 high temperature water 34 from the body of water 33 to the primary apparatus 41 may comprise heating water from the body of water 33 to provide the high temperature water 34. As such, in certain embodiments, the high temperature water 34 which exits the plurality of third fluid passageways 11 and the low temperature water 35 may flow through the first fluid passageway 9 to act as a coolant. In such embodiments, the apparatus shown in FIG. 7 may be used where the outlet 217 of the plurality of third fluid passageways 211 is fluidly connected to the inlet 212 of first fluid passageway 209. In such embodiments, the first method may comprise providing a membrane distillation apparatus 201 according to the embodiment shown in FIG. 7.

The high temperature water 34 may be recirculated through the first fluid passageway 9, 109 and the plurality of third fluid passageways 11, 111 until a desired amount of the vaporous permeate has been separated from the high temperature water 34.

In certain embodiments, the step of providing the membrane distillation apparatus 1 may comprise providing air, a partial vacuum, a vacuum, a porous material or a liquid within the plurality of second fluid passageways 10. Thus, the plurality of second fluid passageways 10 may comprise (i.e. be filled with) air, a partial vacuum, a vacuum, a porous material or a liquid. The contents of the second fluid passageways 10 may enable the method to utilise different techniques for membrane distillation.

In embodiments where the plurality of second fluid passageways 10 comprise air, the method uses air gap membrane distillation. The vaporous permeate may pass through the air in the plurality of second fluid passageways 10 and condense on the plurality of inner conduits 3. The condensed permeate then flows downwards under gravity or by pumping towards the outlet 16 of the plurality of second fluid passageways 10.

In embodiments where the plurality of second fluid passageways 10 comprise a partial vacuum, the method may use vacuum-assisted membrane distillation. In such embodiments, the partial vacuum increases the difference in vapour pressure for driving the vaporous permeate of the high temperature water 34 through the plurality of hollow fibre membranes 4 into the plurality of second fluid passageways 10. The partial vacuum causes the vaporous permeate to be drawn out of the membrane distillation apparatus 1 at the outlet 16 of the plurality of second fluid passageways 10. The vaporous permeate may be condensed in a condenser which is separate to the membrane distillation apparatus 1. The condenser may be part of the primary apparatus 41. Alternatively, the vaporous permeate may be condensed in the plurality of second fluid passageways 10, for example, the vaporous permeate may condense on the plurality of inner conduits 3.

In embodiments where the plurality of second fluid passageways 10, 110 comprise a vacuum, the first method may use vacuum membrane distillation, respectively. In such embodiments, the vacuum creates the difference in vapour pressure for driving the vaporous permeate of the high temperature water 34 through the plurality of hollow fibre membranes 4 into the plurality of second fluid passageways 1. In such embodiments, the low temperature water enables the vaporous permeate of the high temperature water 34 condenses in the plurality of second fluid passageways on the inner conduit 3.

In embodiments where the where the plurality of second fluid passageways 10 comprise a porous material, the porous material may help to facilitate condensation of the vaporous permeate within the second fluid passageways 10. Additionally, the porous material may reduce thermal losses from the plurality of third fluid passageways 11 due to the coolant in the first fluid passageway 9.

In embodiments where the plurality of second fluid passageways 10 comprise a liquid, the method may use osmotic distillation. In such embodiments, the plurality of second fluid passageways 10 comprise a liquid that has a lower concentration of the dissolved mineral than the high temperature water 34. In such embodiments, the liquid comprises freshwater. The concentration gradient may increase the difference in vapour pressure for driving the vaporous permeate of the high temperature water 34 (i.e. the solvent) through the plurality of hollow fibre membranes 4 into the plurality of second fluid passageways 10. This may be used in addition to the above-described temperature gradient provided by the coolant. The liquid enters the plurality of second fluid passageways 10, 110 through the inlet 13 of the plurality of second fluid passageways 10 and exits together with the permeate through the outlet 16 of the plurality of second fluid passageways 10.

Alternatively, the first method may use sweep gas membrane distillation. Non-limiting examples of the sweep gas include air and nitrogen. In such embodiments, the step of extracting the permeate of the high temperature water 34 from the plurality of second fluid passageways 10 comprises feeding a sweep gas through the plurality of second fluid passageways 10. The sweep gas enters the plurality of second fluid passageways 10 through the inlet 13 of the plurality of second fluid passageways 10. The vaporous permeate is removed from the membrane distillation apparatus 1 together with the sweep gas at the outlet 16 of the plurality of second fluid passageways 10. The vaporous permeate may then be condensed in a condenser which is separate to the membrane distillation apparatus 1.

A second method for distilling the high temperature water 34 may comprise providing a membrane distillation apparatus 1, 201 according to the embodiments shown in FIGS. 4 and 5 or in FIG. 7 and feeding a high temperature water 34 through the plurality of second fluid passageways 10, 210. Feeding the high temperature water 34 through the plurality of second fluid passageways 10, 210 may comprise feeding the high temperature water 34 at a pressure that is less than the liquid entry pressure of the hydrophobic material of the plurality of the hollow fibre membranes 4, 204. The temperature of the high temperature water 34 may be increased compared to the temperature of the water at or towards the surface of the body of water 33 prior to entering the plurality of second fluid passageways 10, 110.

During the second method, the vapour pressure in the plurality of second fluid passageways 10, 210 is greater than the vapour pressure in the plurality of third fluid passageways 11, 211 of the apparatuses 1, 201 of FIGS. 4, 5 and 7. As described above in the method of the first embodiment, this difference in vapor pressure drives a vaporous permeate (i.e. freshwater vapour) of the high temperature water 34 through the hydrophobic material of the plurality of hollow fibre membranes 4, 204 into the plurality of third fluid passageways 11, 211.

The permeate is therefore separated from the high temperature water 34 by membrane distillation. In the invention, the difference in vapor pressure between the plurality of third fluid passageways 11, 211 and the plurality of second fluid passageways 10, 210 is created by a temperature gradient between the plurality of second fluid passageways 10, 110 and the plurality of third fluid passageways 11, 111. The temperature gradient is provided by a freshwater coolant (i.e. a coolant consisting of freshwater) having a lower temperature that the high temperature water 34 flowing through the plurality of third fluid passageways 11, 111. The freshwater coolant is cooled prior to entering the plurality of third fluid passageways 11, 111 by the low temperature water 35 via a heat exchanger. Thus, in certain embodiments, the primary apparatus 41 may comprise the membrane distillation apparatus as shown in FIG. 4, 5 or 7 and a heat exchanger.

Once the vaporous permeate enters the plurality of third fluid passageways 11, 211, it is extracted from the plurality of third fluid passageways 11, 211 along with the freshwater coolant. The permeate and freshwater coolant are extracted through the outlet 17, 217 of the plurality of third fluid passageways 11, 211.

During the method, the high temperature water 34 may be recirculated through the membrane distillation apparatus 1, 201. That is, once the high temperature water 34 has passed through the outlet 16, 216 of the plurality of second fluid passageways 10, 210 it may be directed back into the inlet 13, 213 of the plurality of second fluid passageways 10, 210.

In the first and second methods for distilling the high temperature water 34, the high temperature water 43 and permeate may flow along the fluid passageways in the membrane distillation apparatus 1, 201 at a rate from 0.5 to 10 litres per minutes and at a pressure of from 1 to 10 bar. However, the flow rates and pressures are not limited to these ranges. For example, the membrane distillation apparatus 1, 201 could be used for high pressure filtration which exceeds 30 bar. Exemplary flow rates through the hollow membrane fibres 4, 204 are from 1 to 40 litres per square meter per hour and will vary depending on the temperature of the high temperature water 34, the flow rate, heat recovery and the chemistry of the high temperature water 34. Typically, the temperature of the high temperature water 34 entering the membrane distillation apparatus 1, 201 is in the range from 10 to 80° C.

The membrane distillation apparatus 1 of FIGS. 3 to 7 and first and second methods of distillation may improve the separation of the freshwater vapour from the high temperature water 34. Including a plurality of hollow fibre membranes within each inner conduit of the apparatus provides a large surface area through which a permeate may pass. Providing three different fluid passageways within the apparatus enable temperature regulation of fluids in the apparatus and facilitates condensation of a permeate within the apparatus. The apparatuses and methods may therefore improve the efficiency of and reduce the energy required for separating freshwater vapour from the high temperature water 34. Including a plurality of inner conduits within the outer conduit further improve these efficiencies and reduce the energy requirements.

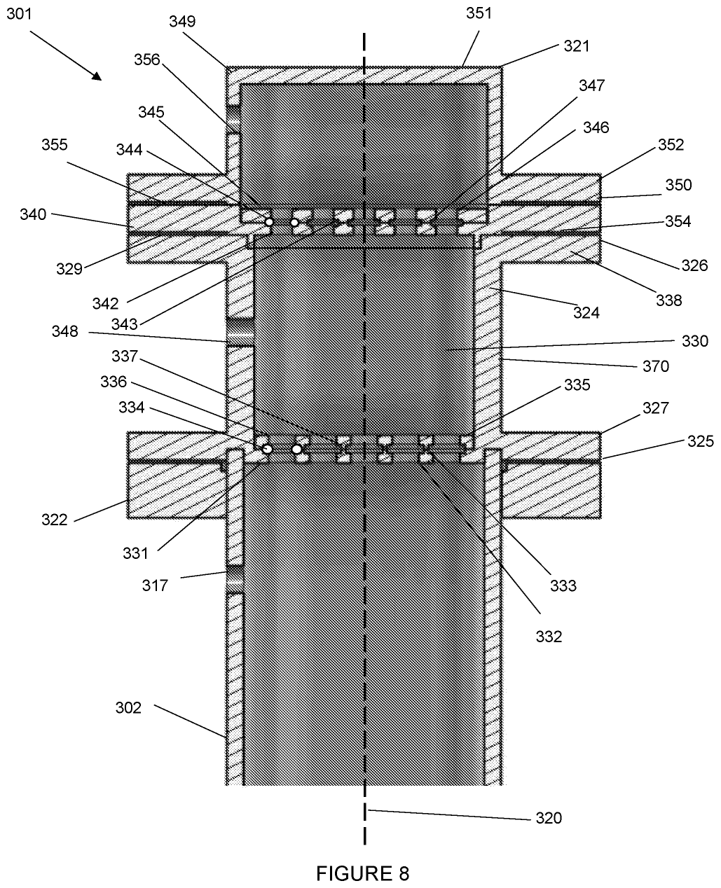

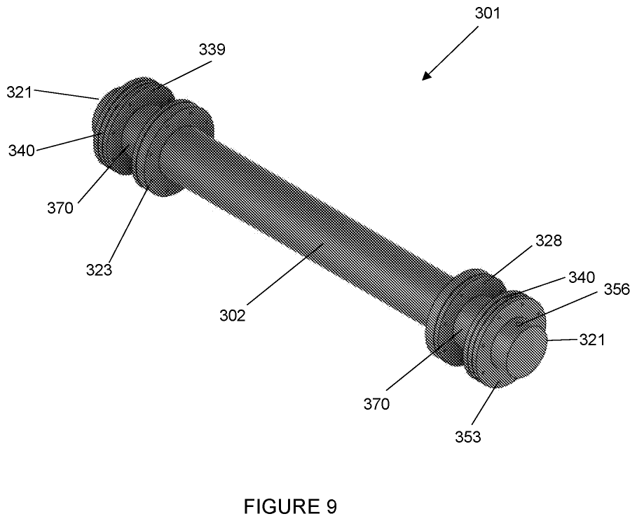

FIGS. 8 and 9 shows an apparatus 301 according to another embodiment of the invention. The apparatus 301 is substantially the same as the apparatus 1 of FIGS. 4 to 6 except in how the outer and inner conduits are fluidly sealed. That is, the apparatus 301 of FIGS. 8 and 9 comprises first collar 370, second collar 340 and cap 321 which differ from the first and second caps 5, 7 described for the apparatus 1 in the embodiment of FIGS. 4 to 6. The apparatus 301 may be used in the embodiment shown in FIG. 7. Thus, the apparatus 301 may be used in combination with the common fluid passageways 218. Reference numerals in FIGS. 8 and 9 correspond to those used in FIGS. 4 to 6 for like features but are transposed by 300. The apparatus 301 may be used in any of the above-described methods. The apparatus 310 may be used in the method 30 for performing a primary and a secondary process using thermal energy of a body of water 33 comprising a dissolved mineral. The apparatus 301 may be used as the membrane distillation apparatus 42 in each of the embodiments of FIGS. 2 and 3.

As shown in FIG. 8, the apparatus 301 comprises an outer conduit 302. The outer conduit 302 may comprise a two openings 317 to allow fluid to enter and exit the first fluid passageway. The openings 317 may be in the side walls of the outer conduit 302. The outer conduit 302 may include all features of the outer conduit 2 described in reference to the apparatus 1 in FIGS. 4 to 6. The outer conduit 302 may additionally comprise a flange 322 positioned at each end of the outer conduit 302. Each flange 322 may surround one end of the outer conduit 302. The flange 322 may comprise a plurality of holes 323 extending therethrough. The holes 323 may be configured to receive fasteners (not shown), such as a threaded fastener like a bolt or a screw. The bolt may be configured to receive a nut.

Whilst not shown, the apparatus 301 is configured to receive a plurality of inner conduits and a plurality of hollow fibre membranes within each of the inner conduits. The apparatus 301 is configured to receive inner conduits and hollow fibre membranes that are substantially the same and arranged in the same manner as those described in reference to the apparatus in FIGS. 4 to 6. Thus, the apparatus 301 may provide: a first fluid passageway provided between the outer conduit 302 and the plurality of inner conduits; a plurality of second fluid passageways provided between each of the inner conduits and the plurality of hollow fibre membranes within that conduit; and a plurality of third fluid passageways, each of the third fluid passageways being within one of hollow fibre membranes the apparatus 301 is configured to receive.

As shown in FIGS. 8 and 9, the apparatus 301 comprises at least one first collar 370. The first collar 370 may be configured to be secured to an end of the outer conduit 302. As shown in FIG. 9, the apparatus 301 may comprise two first collars 370, each first collar 370 being securable to one end of the outer conduit 302.

The first collar 370 may comprise a body 324 extending from a first end 325 to a second end 326. The first collar 370 may comprise a first flange 327 to facilitate securing of the first collar 370 to the outer conduit 302. The first flange 327 may be positioned at the first end 325 of the body 324. The first flange 327 and the body 324 may be formed as one piece or the first flange 327 may be secured to the body 324. The first flange 327 may comprise a plurality of holes 328 arranged to align with the holes 323 in one of the flanges 322 of the outer conduit 302. The holes 322 in the first flange 327 may also be configured to receive fasteners (not shown). Thus, the first collar 370 may be secured to the outer conduit 302 by aligning the holes 323 in the flange 322 of the outer conduit 302 and the holes 328 in the first flange 327 then inserting the fasteners through the holes 323, 328.

The apparatus 301 may comprise a first gasket 329 arranged between the flange 322 of the outer conduit 302 and the first flange 327 of the first collar 370. The first gasket 329 may fluidly seal the outer conduit 302 to the first collar 370.

As shown in FIG. 8, the body 324 of the first collar 370 comprises a passage 330 extending therethrough so that the inner conduits may extend into the first collar 370 from the outer conduit 302. As such, the first collar 370 may have a substantially hollow interior. The passage 330 through the first collar 370 may be substantially cylindrical. The passage 330 may have a diameter less than or equal to an internal diameter of the outer conduit 302.

The first collar 370 may comprise a fixed insert 331 which extends across the passage 330 of the first collar 370. The fixed insert 331 may be positioned at or towards the first end 325 of the first collar 370. The fixed insert 331 is in a fixed in position relative to the body 324 of the first collar 370.

The fixed insert 331 comprises a plurality of apertures 332. Each aperture 332 is configured to receive one of the inner conduits. As such, the inner conduits may extend from the outer conduit 302 into the first collar 370. The diameter of each aperture 332 in the fixed insert 331 may be the same as or larger than an outer diameter of the inner conduits. The fixed insert 331 comprises the same number of apertures 332 as the number of inner conduits the outer conduit 302 is configured to receive.

The fixed insert 331 may comprise a groove 333 extending circumferentially around each aperture 332 on one side of the insert 331. The grooves 333 may be positioned on the side of the fixed insert 331 facing towards the second end 326 of the body 324. The first collar 370 may comprise a plurality of first o-rings 334. The grooves 333 are configured to partially receive one of the plurality of first o-rings 334. The first o-rings 334 may comprise an elastomeric material. In FIG. 8, for simplicity only one of the grooves 333 is shown as having a first o-ring 334 residing therein. However, all grooves 333 are configured to receive a first o-ring 334.

The apparatus 301 may comprise a first removable insert 335. The first removable insert 335 is releasably securable to the body 324 of the first collar 370. The first removable insert 335 may be configured to extend across the passage 330 of the first collar 370. Thus, the first removable insert 335 may have the same diameter as the diameter of the passage 330 of the first collar 370.

The first removable insert 335 may comprise a plurality of apertures 336. The apertures 336 in the first removable insert 335 correspond to the apertures 332 in the fixed insert 331. That is, apertures 336 in the first removable insert 335 have the same shape, size and distribution as the apertures 332 in the fixed insert 331. Thus, each aperture 336 in the first removable insert 335 is configured to receive one of the inner conduits.

The first removable insert 335 may comprise a groove 337 extending circumferentially around the of each aperture 336 on one side of the insert 334. In the same manner as the fixed insert 331, the grooves 337 in the first removable insert 335 may be configured to partially receive one of the plurality of first o-rings 334.

The fixed insert 331 and the first removable insert 335 comprise a plurality of holes (not shown) configured to receive fasteners (not shown). Non-limiting examples of the fasteners include as a threaded fastener such as a bolt or a screw. The bolt may be configured to receive a nut. The holes may be positioned between the apertures 332, 336 in each of the inserts 331, 335. The holes in the fixed insert 331 and first removable insert 335 are arranged so that the inserts 331, 335 may be secured together by the fasteners. FIG. 8 shows the fixed insert 331 secured to the first removable insert 335. The first removable insert 335 may be secured to the fixed insert 331 so that the grooves 337 surrounding the apertures 336 in the first removable insert 335 are next to with the grooves 333 surrounding the apertures 332 in the fixed insert 331. As such, each of the first o-rings 334 may reside between within the grooves 333, 337 between the two inserts 331, 335. The axial height of the first o-rings is greater than the combined axial height of the grooves 333, 337 in the fixed and first removable inserts 331, 335. The height of the first o-rings 334 and the grooves 333, 337 is in a direction parallel to the longitudinal axis 320 shown in FIG. 8.

The fixed and first removable inserts 331, 335 are configured so that as the inserts 331, 335 are secured together the first o-rings 334 are compressed axially. This results in radial expansion of the first o-rings 334. As such, when the inserts 331, 335 are secured together the first o-rings 334 form a fluid tight seal around inner conduits that extend through the apertures 332, 336. Therefore, fluid within the first fluid passageway, between the outer conduit 302 and the plurality of inner conduits, is prevented from passing through the first collar 370. The first collar 370 may therefore fluidly seal the ends of the outer conduit 302.

At the second end 326 of the body 324, the first collar 370 may comprise a second flange 338. In the same manner as the first flange 327 of the first collar 370, the second flange 338 comprises a plurality of holes 339 configured to receive fasteners. The second flange 338 and the body 324 may be formed as one piece or the second flange 338 may be secured to the body 324.

As shown in FIG. 8, the apparatus 301 may comprise at least one second collar 340. As shown in FIG. 9, the apparatus 301 may comprise two second collars 340, each second collar 340 being securable one of the first collars 370. The second collar 340 is configured to be secured to the second flange 338 of the first collar 370. As such, the second collar 340 may comprise a plurality of holes (not shown) which correspond to the holes 339 in the second flange 338 of the first collar 324 so that the second collar 340 and the second flange 338 may be secured together by a plurality of fasteners (not shown), such as a threaded fastener like a bolt or a screw. The bolt may be configured to receive a nut.

The second collar 340 is arranged to cover the passage 330 in the first collar 324. The second collar 340 comprises a plurality of apertures 342. As described above, a plurality of hollow fibre membranes is within each of the inner conduits. Each aperture 342 in the second collar 340 is configured to receive the plurality of hollow fibre membranes from one of the inner conduits. As such, plurality of hollow fibre membranes extend from the first collar 370 through the second collar 340. However, the inner conduits do not pass through the second collar 340. The apertures 342 in the second collar 340 may have a smaller diameter that the outer diameter of the inner conduits. When the apparatus 301 is assembled, the inner conduits pass through the apertures 332, 336 in the fixed and first removable inserts 331, 335 of first collar 370 into the passage 330 in the first collar 370. The inner conduits end within the first collar 370. The plurality of hollow fibre membranes extend from the end of their respective inner conduit and pass through the second collar 340.

Each of the plurality of inner conduits comprises a plurality of hollow fibre membranes disposed therein. Thus, each of the plurality of inner conduits comprises a bundle of hollow fibre membranes. The plurality of hollow fibre membranes in each bundle may be secured together by a support (not shown). The support may hold the plurality of hollow fibre membranes in each bundle in a fixed position relative to one another.

The support may comprise a solid cylinder having a plurality of apertures through which the plurality of hollow fibre membranes extend. The support may comprise a potting material to fixedly hold the plurality of hollow fibre membranes relative to one another. Alternatively, the hollow fibre membranes may be secured within the apertures by a potting material. The potting materials may comprise any suitable material for fixing the plurality of hollow fibre membranes in place. Suitable potting materials include but are not limited to epoxy, polyurethane and silicone adhesives.

The support may be positioned on the plurality of hollow fibre membranes so that the support resides in the apertures 342 of the second collar 340 when the plurality of hollow fibre membranes are positioned within the inner conduits in the apparatus 301. Thus, the diameter of the apertures 342 in the second collar 340 may be the same as or larger than the outer diameter of the support.

The second collar 340 may comprise a groove 343 extending circumferentially around each aperture 342 on one side of the second collar 340. The apparatus 301 may comprise a plurality of second o-rings 344. In a similar manner to the fixed and first removable inserts 331, 335 of the first collar 324, the grooves 343 in the second collar 340 are configured to partially receive one of the plurality of second o-rings 344. The second o-rings 344 may comprise an elastomeric material. In FIG. 8, for simplicity only one of the grooves 343 is shown as comprising a second o-ring 344. However, all grooves 343 are configured to receive a second o-ring 344.

The apparatus 301 may comprise a second removable insert 345. The second removable insert 345 is releasably securable to the second collar 340. The second removable insert 345 may be arranged to cover the passage 330 in the first collar 370. The second removable insert 345 comprises a plurality of apertures 346. Each aperture 346 is configured to receive the plurality of hollow fibre membranes from one of the inner conduits. In particular, the apertures 346 in the second removable insert 345 are configured to receive the support of the plurality of hollow fibre membranes from one of the inner conduits. The apertures 346 in the second removable insert 345 correspond to the apertures 342 in the second collar 340. That is, apertures 346 in the second removable insert 345 have the same shape, size and distribution as the apertures 342 in the second collar 340.

The second removable insert 345 may comprise a groove 347 extending circumferentially around the of each aperture 346 on one side of the insert 345. In the same manner as the second collar 340, the grooves 347 in the second removable insert 345 are configured to receive one of the plurality of second o-rings 344.

The second collar 340 and second removable insert 345 comprise a plurality of holes (not shown) configured to receive fasteners (not shown). Non-limiting examples of the fasteners include as a threaded fastener such as a bolt or a screw. The holes may be positioned between the apertures 342, 346 in each of the second collar 340 and the insert 345. The holes in the second collar 340 and the second removable insert 345 are arranged so that the second collar 340 and the insert 345 may be secured together by fasteners. FIG. 8 shows the second removable insert 345 secured to the second collar 340. The second removable insert 345 is secured to the second collar 340 so that the grooves 347 surrounding the apertures 346 in the second removable insert 345 are next to with the grooves 343 surrounding the apertures 342 in the second collar 340. As such, each second o-ring 344 may reside between within the grooves 343, 347 between the second collar 340 and the second removable insert 345. The axial height of the second o-rings 344 is greater than the combined axial height of the grooves 342, 346 in the second collar 340 and second removable insert 345. The height of the second o-rings 344 and the grooves 342, 346 is in a direction parallel to the longitudinal axis 320 shown in FIG. 8.

The second collar 340 and second removable insert 345 are configured so that when they are secured together the plurality of o-rings second 344 are compressed axially. This results in radial expansion of the second o-rings 344. As such, the second o-rings 344 provide a fluid tight seal around support of each of the plurality of hollow fibre membranes that extend through the apertures 342, 346. Therefore, fluid within the second fluid passageways, between each of the inner conduits and the plurality of hollow fibre membranes within the conduit, is prevented from passing through the second collar 340. The second collar 340 may therefore fluidly seal the ends of the inner conduits. The first collar 370 may comprise an opening 348 to allow fluid to enter and exit the second fluid passageways. As shown in FIG. 8, the opening 348 may be in a side wall of the first collar 370.

As shown in FIGS. 8 and 9, the apparatus 301 may comprise at least one cap 321. As shown in FIG. 9, the apparatus 301 may comprise two caps 321, each cap 321 being securable one of the second collars 340. The cap 321 may comprise body 349 having first open end 350 and a second closed end 351.

The cap 321 is configured to be secured to the second collar 340. The cap 321 may comprise flange 352 to secure the cap 321 to the second collar 340. The flange 352 may be at the first end 350 of the cap 321. The flange 352 of the cap 321 may comprise a plurality of holes 353 which correspond to those in the second collar 340 and in the second flange 338 of the first collar 370 so that the cap 321, the second collar 340 and the first collar 370 may be secured together as shown in FIG. 9. The cap 321, the second collar 340 and the second flange 338 of the first collar 370 may be secured together by a plurality of fasteners (not shown). The fasteners may comprise threaded fasteners, such as a bolt or a screw. The bolt may be configured to receive a nut. In alternative embodiments, cap 321, the second collar 340 and the first collar 370 may be configured such that cap 321 and the second collar 340 are secured to each other by one set of fasteners and the first collar 370 and the second collar 340 are secured to each other by a different set of fasteners.

The apparatus 301 may comprise a second and a third gasket 354, 355. The second gasket 354 maybe arranged between the second flange 338 of the first collar 370 and the second collar 340. The third gasket 355 may be arranged between the second collar 340 and the flange 352 of the cap 321. The second and third gaskets 354, 355 may fluidly seal the first collar 370 to the second collar 340 and the second collar 340 to the cap 321, respectively.

The cap 321 is configured to receive the plurality of hollow fibre membranes. That is, when the hollow fibre membranes are within the apparatus 301, they extend through the first collar 370 and through the second collar 340 into the cap 321. Thus, fluid may pass between interior of the cap 321 and third fluid passageways within the hollow fibre membranes. However, the first and second plurality of o-rings 334, 344 fluidly seal the inner conduits and the outer conduit 302 from the cap 321. Thus, the cap 321 is fluidly isolated from the first fluid passageway and the second fluid passageways. The cap 321 may comprise an opening 356 to allow fluid to enter and exit the third fluid passageways. As shown in FIG. 8, the opening 356 may be formed in a side wall of the cap 321.

Whilst FIG. 8 shows one end of the apparatus 301, each of end of the apparatus 301 may be identical as shown in FIG. 9. That is, each end of the apparatus 301 may comprise an first collar 370, a second collar 340 and an cap 321.

To assemble the apparatus 301 of FIGS. 8 and 9, a plurality of hollow fibre membranes are placed within each inner conduit. The support may be provided either before or after the hollow fibre membranes are placed in the inner conduits. The inner conduits enclosing the plurality of hollow fibre membranes are then placed within the outer conduit 302. The inner conduits are configured to extend out of each end of the outer conduit 302 and the hollow fibre membranes are configured to extend out of each end of their inner conduits.

A removable jig may be used to keep the inner conduits and hollow fibre membranes in the correct position at one of the outer conduit 302 whilst the first collar 370, the second collar 340 and the cap 321 are attached to the other end of the outer conduit 302.

To secure the first collar 370 to the outer conduit 302, the first collar 370 is placed over the inner conduits so that the inner conduits extend through the apertures 332 in the fixed insert 331 of the first collar 370. The first collar 370 may be secured to the outer conduit 302 via fasteners extending through the holes 323, 328 in the first flange 327 of the first collar 370 and the flange 322 of the outer conduit 302. The plurality of first o-rings 334 may be located into the grooves 333 in the fixed insert 331 of the first collar 321.

The first removable insert 335 may then be placed onto the inner conduits and secured to the fixed insert 331 of the first collar 321. As the first removable insert 335 is secured to the fixed insert 331, the plurality of first o-rings 334 are compressed between the inserts 331, 335 to provide a fluid tight seal around the inner conduits.

The second collar 340 may then be placed on the first collar 370 so that the plurality of hollow fibre membranes extend through the apertures 342 in the second collar 340. The second collar 340 may be positioned so that the supports on the plurality of hollow fibre membranes reside within the apertures 342 in the second collar 340. The plurality of second o-rings 344 may be located into the grooves 343 in the second collar 340.

The second removable insert 345 may then be placed over the plurality of hollow fibre membranes so that the membranes extend through the apertures 346 in the second removable insert 345. The second removable insert 345 may be secured to the second collar 340 causing the second plurality of o-rings 344 to be compressed between the insert 345 and the second collar 340 thereby providing a fluid tight seal around the supports and the hollow fibre membranes.

The end cap 321 may then be located on the second collar 340. The end cap 321, second collar 340 and first collar 370 may then be secured together. Thus, the first collar 370, cap 321 and the second collar 340 are secured to one end of the outer conduit. The removable jig may then be removed from the other end of the outer conduit 302 and the process may be repeated.

The features of the apparatus 301 shown in FIGS. 8 and 9, may improve ease of assembly and dismantling of the apparatus 301 compared to, for example, an apparatus in which the membranes and/or inner conduits are secured within the apparatus by welding or an adhesive. This may enable greater ease of replacing the membranes in the apparatus and cleaning the apparatus. As such, the entirety of the apparatus 301 does not need to be replaced when the membranes need replacing.

In one embodiment, the secondary process may comprise using the low temperature water 35 in an air conditioning system. In such embodiments, the apparatus 32 may comprise means for conveying the low temperature water to a secondary apparatus 71 where the secondary apparatus 71 comprises the air conditioning system. The cooling properties of the low temperature water are therefore used both for desalination of water and for air conditioning. As such, the method provides a single process which minimising the energy costs associated with desalination and with air conditioning.

In certain embodiments, the method 30 may comprise extracting the high temperature water 34 from the primary apparatus 41 after the primary process has been performed, and conveying the high temperature water 34 to the air conditioning system. Thus, the secondary process may comprise using the high temperature water 34 in the air conditioning system. As such, the air condition system may be configured to receive the high temperature water 34. In alternative embodiments, the high temperature water 34 may be removed from the primary apparatus 31, 32 after the primary process has been performed and returned to the body of water 33 or the high temperature water 34 used in a tertiary process.

The air conditioning system may comprise a closed fluid loop 73 within a building 74. The closed fluid loop 73 comprises a coolant and is configured to circulate the coolant around the building 74. The coolant in the closed fluid loop 73 is cooled by the low temperature water 35 via a heat exchanger 72 and then circulated around the building 74. Since low temperature water 35 is sourced from below the surface of the body of water 33, the temperature of the low temperature sea water 35 is lower that the air temperature near the body of water 33 and in the building 74. Thus, as the coolant circulates around the building 74 the air temperature in the building 74 is reduced.

In certain embodiments, the coolant within the closed fluid loop 73 may be cooled by an auxiliary chiller (not shown) in addition to being cooled by the low temperature water 35 via the heat exchanger 72. The auxiliary chiller may be used when a desired temperature within the building 74 cannot be reached by relying only on the temperature of the low temperature water 35. In such embodiments, the air conditioning system is configured such that after the coolant has been cooled by the heat exchanger 72 the coolant passes through the auxiliary chiller before being circulated through the building 74. The auxiliary chiller is configured to lower the temperature of the coolant. The auxiliary chiller comprises a refrigeration system having a condenser and an evaporator. The coolant passes through the evaporator of the auxiliary chiller. The condenser is cooled by the low temperature sea water 35 after the low temperature sea water 35 has passed through the heat exchanger 72. Thus, the low temperature water may increase the condenser efficiency of the refrigeration cycle.

In alternative embodiments, the high temperature water 34 may be used in addition to or instead of the low temperature water 35 in the air conditioning system. The high temperature water 34 may be used in the air conditioning system when the temperature of the high temperature water 34 is lower than the air temperature near the body of water 33 and in the building 74. In certain embodiments, the high temperature water 34 may be used to cool the condenser of the auxiliary chiller instead of the low temperature water 35. In such embodiments, thermal energy extracted from the coolant in the closed fluid loop increases the temperature of the high temperature water 34. As such, after use in the air conditioning system the high temperature water 34 may be returned to the primary apparatus 41 so that the temperature of the high temperature water may be used to drive the membrane distillation. The membrane distillation apparatus 42 may be configured to receive the high temperature water 34 from the air conditioning system. When the high temperature water is used to cool the condenser, the low temperature water may be used for other processes including but not limited to carbon sequestering, aquaculture, cosmetics production and electricity generation via a Rankine cycle.

Using the low temperature water 35 in the air conditioning system reduces the energy costs and environmental impact of running the system compared to conventional air conditioning systems. If the low temperature water 35 has a flow rate of 2840 litres per second (approximately 45,000 gallons per minute) into the air conditioning system and a temperature of 7 to 14° C., the low temperature water 35 could provide a cooling capacity of up to 22,290 tons (i.e. 79.4 MW as 1 ‘ton’ of air conditioning does not relate directly to a weight but is equivalent to 3516.85 W of power).

In another embodiment, the secondary process may comprise using the low temperature water 35 for carbon sequestering. Thus, the apparatus 32 may comprise means for removing the low temperature water 35 from the primary apparatus 41 and means for using 75 the low temperature water 35 in a secondary process of carbon sequestering. The properties of the low temperature water are used both for desalination of water and carbon sequestering. As such, the method provides a single process which minimises the energy costs associated with desalination and helps reduce the amount of atmospheric carbon dioxide. Thereby reducing the environmental impact of water desalination.

It is known that bodies of water such as oceans and seas store vast quantities of carbon in the form of simple organic compounds, carbonate minerals and biological organisms which form part of the biological carbon pump. Typically, the quantity of carbon in water in an ocean or sea increases with the depth of the water below the surface. Natural upwellings of nutrient-rich water from the ocean or sea depths are associated with algal blooms occurring at the surface.

These are caused by the accelerated growth and reproduction of phytoplankton which use atmospheric carbon dioxide in the process of photosynthesis. The phytoplankton in turn are predated by zooplankton, which in turn may be predated by organisms higher up the food chain. At each stage, carbon in the form of organic waste is excreted and may be consumed by other organisms or may sink to the ocean floor where it can remain for millennia. Thus, the presence of nutrients at the surface of oceans and seas reduces atmospheric carbon dioxide and sequesters atmospheric carbon dioxide in the ocean.

As described above, the low temperature water 35 may be sourced from below the surface of the body of water 33, for example, from at least 600 m below the surface. Thus, the low temperature water 35 includes a higher nutrient content that water at the surface of the body of water 33. The step of carbon sequestering may comprise releasing the low temperature water 35 at or below the surface of the body of water 33 thereby utilising the higher nutrient content of the low temperature water to accelerate the biological carbon pump. Additionally, releasing the low temperature water 35 into the body of water increases the circulation of water within the body of water compared to the naturally occurring circulation and accelerates the biological carbon pump. The apparatus 32 may comprise means for releasing the low temperature water 35 at or below the surface of the body of water 33.

In certain embodiments, the step of carbon sequestering may also comprise fertilising the low temperature water 35 prior to releasing the low temperature water 35. Alternatively, the step of carbon sequestering may also comprise fertilising the water at the surface of the body of water 33 prior to releasing the low temperature water 35. Fertilisation may further enhance carbon sequestering. The low temperature sea 34 water may be fertilised by adding nutrients such as including soluble iron, phosphorus, nitrogen, silicon or mineral olivine to the low temperature water 35. For example, soluble iron, specifically FeSO₄·7H₂O, may be added to the low temperature water 35 such that the amount of iron in the low temperature water is 100 mol/km². Alternatively, municipal, industrial or agricultural wastewater which are rich in such nutrients may be added to the low temperature water 35. Adding wastewater to the low temperature water may aid in reducing the pollution of land surface waters such as lakes and rivers by such wastewater. The apparatus 32 may comprise means for fertilising 75 the low temperature water 35 prior to releasing the low temperature water 35 or means for fertilising water at the surface of the body of water 33 prior to releasing the low temperature water 35.

In certain embodiments, the high temperature water 34 may also be used in the secondary process of carbon sequestering. The secondary process may comprise removing the high temperature water 34 and the low temperature water 35 from the primary apparatus 41 after the primary process has been performed. Then, the low temperature water 35 and high temperature water 34 may be mixed together. The resulting mixture of the low temperature 35 and high temperature water 34 may then be used for carbon sequestering by fertilising the mixture prior to releasing the mixture at the surface of the body of water 33. Alternatively, the water at the surface of the body of water 33 may be fertilised prior to releasing the mixture at the surface of the body of water 33. The mixture of the low temperature 35 and high temperature water 34 or water at the surface of the body of water 33 may be fertilised in the same manner as described above for the low temperature water 35. In such embodiments, the apparatus 32 may comprise means for mixing 75 the low temperature water 35 and high temperature water 34. The apparatus may comprise means for fertilising the mixture of the low temperature 35 and high temperature water 34 prior to releasing the mixture at the surface of the body of water 33 or fertilising water at the surface of the body of water 33 prior to releasing the mixture at the surface of the body of water 33.

As described above, releasing the low temperature water 35 at or below the surface of the body of water 33 increases the biological carbon pump by, for example, increasing algal and plankton growth due to the nutrients in the water 33. Thus, the amount of carbon captured by water near the surface of the body of water 33 may be increased. This may occur when only the low temperature water 35 is released, when the water at the surface of the body of water 33 or the low temperature water is fertilised or when the high temperature water 34 is mixed with the low temperature water 35. Carbon may be most efficiently captured in the body of water 33 at depths where sunlight penetrates sufficiently to support the growth of algae and phytoplankton. For example, in an ocean this may occur in the photic and shallow-aphotic zones of an ocean which may be up to approximately 400 m below the surface of the body of water 33.

In a body of water 33, currents may recirculate water which is near the surface. Thus, some of the carbon which has been captured near the surface of the body of water 33, for example in the upper 400 m of the body of water 33, may be recirculated within the upper 400 m of the body of water 33. The carbon may then be released from the body of water 33 which may reduce the length of time the carbon is stored or sequestered.

Carbon may be more easily stored for prolonged periods in the body of water 33 if it is at depths below the surface currents. Therefore, in certain embodiments, the step of carbon sequestering may comprise drawing down or pumping water from near the surface of the body of water 33 to a lower depth. This may be done after the low temperature water has been released at or below the surface of the body of water 33. Thus, once the low temperature water that was released at or below the surface of the body of water 33 has mixed with water residing in the body of water, the resulting mixture may be drawn down to a lower depth below the surface of the body of water 33.

The mixed water may be pumped from, for example, between 0 and 400 m below the surface of the body of water to 900 m or more below the surface of the body of water 33. In such embodiments, the apparatus 32 may comprise one or more drawdown pipes (not shown) arranged with an upper opening at around 400 m below the surface of the body of water 33 and a lower opening around to 900 m or more below the surface of the body of water 33. The apparatus 32 may comprise a pump (not shown) within each drawdown pipe to draw water from near the surface deeper into the body of water 33. Once the mixed water has passed through the pipe it may be below currents may recirculate it to the surface. Thus, the carbon may be stored for longer periods within the ocean.

In such embodiments, the lower end of the drawdown pipe may be sufficiently far from the source of the low temperature water 35 so that the mixed water is not recycled through the apparatus 32. In certain embodiments, the apparatus 32 may comprise means for providing the low temperature water 35 to the primary apparatus 41. This may comprise an intake pipe (not shown) configured to supply the primary apparatus 41 with low temperature water 35. To provide the low temperature water 35, the intake pipe may have an inlet at least 600 m below the surface of the body of water 33. The intake pipe may comprise a pump (not shown) arranged to pump the low temperature water 35 from the body of water 33 to the primary apparatus 41. The lower end of the drawdown pipe may be further below the surface of the body of water 33 that the inlet of the intake pipe. For example, in certain embodiments the inlet of the intake pipe may be between 600 m and 700 m below the surface of the body of water 33 and the lower opening of the drawdown pipe may be about 900 m or more below the surface of the body of water 33.

The skilled person would understand that various modifications can be made to the above described embodiments.

In any of the above described membrane distillation apparatuses, the hydrophobic membrane or materials may be formed from any suitable material. Non-limiting examples of suitable materials include polymeric and ceramic materials. For example, the hydrophobic material may comprise polyvinylidene fluoride which is a thermally and a chemically stable material. Alternative non-limiting examples for the hydrophobic materials include polyethersulfone, polysulfone, cellulose acetate, nylon, polypropylene, polyethylene, polytetrafluoroethylene and polyacrylonitrile. Additionally, combinations of polymers may be used for the hydrophobic material. In certain embodiments, the hydrophobic material may comprise a material which repels oil or oil-like substances in addition to water. That is, the hydrophobic material may comprise an omniphobic material. The hydrophobic material or material comprises a plurality of pores through which the water vapour passes. The pore size of the plurality of pores in the hydrophobic membrane may be from 0.1 to 10 microns or from 0.1 to 1 microns.

In any of the embodiments of the membrane distillation apparatus shown in FIGS. 3 to 9, the size of the outer conduit, inner conduit and plurality of hollow fibre membranes may be selected depending on the intended use of the apparatus. The diameter of the outer conduit 2 may be relatively large compared to that of the inner conduits 3 in order to reduce heat loss from the outer surface of the outer conduit. In certain embodiments, the outer conduit 2 may have a diameter of approximately 110 mm. Each of the inner conduits 3 may have an outer diameter of approximately 15 mm. As shown in the embodiment of FIG. 2, the outer diameter of all inner conduits 3 in the apparatus may be the same as each other. The outside diameter of the hollow fibre membranes may be 0.3 mm or greater or the outside diameter of the hollow fibre membranes may be from 0.3 mm to 3 mm. As described above, during use of the apparatus a fluid may flow through the plurality of third fluid passageways 11 (i.e. through the plurality of hollow fibre membranes 4). The smaller the diameter of the hollow fibre membranes 4, the larger the drop in pressure across the length of the membrane 4 that is required for fluid to flow through the membrane 4. Thus, the diameter of the hollow fibre membranes 4 will depend on the intended use of the membrane distillation apparatus 1. Hollow fibre membranes having an outside diameter of 1 mm and an inside diameter of 0.9 mm (i.e. a wall thickness of 0.05 mm) may provide sufficient surface area for the membrane whilst minimising the pressure drop.

The plurality of hollow fibre membranes 4 may have a length from 0.3 m to 4 m. The inner 3 and outer 2 conduits may have a length from 0.3 m to 4 m. The drop in pressure along the hollow fibre membranes 4 increases with the length of the membrane 4. Thus, the length of the hollow fibre membranes 4 will depend on the intended use of the membrane distillation apparatus 1. A hollow fibre membrane 4 length of 1 m may allow sufficient vapour flow through the membrane and an acceptable pressure drop along the membrane.

The volume of each inner conduit 3 which is occupied by the plurality of hollow fibre membranes 4 is selected based on the intended use of the membrane distillation apparatus 1. The packing density of the hollow fibre membranes 4 within each inner conduit 3 provides a measure of the amount of the inner conduit 3 which is filled by the hollow fibre membranes 4. The packing density is the ratio of the surface area of the plurality of hollow fibre membranes 4 to the volume of the inner conduit 3 in which they are contained. As described above, during use of the apparatus a fluid may flow through the plurality of third fluid passageways 11 (i.e. through the plurality of hollow fibre membranes 4) and/or through the plurality of second fluid passageways 10. If the packing density of the hollow fibre membranes 4 is high, for example greater than 20,000 m²/m³ it may result in laminar flow rather than turbulent flow of the fluid. Turbulent flow improves heat transfer through the membrane distillation apparatus 1 whereas laminar flow may reduce heat transfer through the membrane distillation apparatus 1. Furthermore, if the packing density is high a greater pressure is required to drive the fluid along the plurality of second 10 or third fluid passageways 11 through the apparatus. As such, the packing density of the hollow fibre membranes within each inner conduit may be less than 20,000 m²/m³ or less than 10,000 m²/m³. In the embodiments of the membrane distillation apparatus shown in FIGS. 3 to 9, the membrane distillation apparatus comprises a plurality of inner conduits. In alternative embodiments, the membrane distillation apparatus may comprise a single inner conduit and a single second fluid passageway. The first and second methods may also comprise providing an apparatus comparing a single inner conduit and a single second fluid passageway.

In the membrane distillation apparatus shown in FIGS. 3 to 9, there is one inlet and one outlet of all the plurality of second fluid passageways and one inlet and one outlet for all of the plurality of third fluid passageways. In alternative embodiments, there may be a different number of inlets and outlets. For example, each of the second and/or third fluid passageways may have an individual inlet and an individual outlet.

In certain embodiments, more than one membrane distillation apparatus may be provided in the above described first and second methods. For example, the methods may comprise a plurality of apparatuses as shown in the embodiments of FIGS. 4 to 9 connected together in series or in parallel. When a plurality of membrane distillation apparatuses of the embodiment shown in FIG. 4 are connected in series, the apparatuses may be connected such that the high temperature water 34 is recirculated through all the apparatuses. For example, the outlet of the plurality of third fluid passageways of the last apparatus in the series may be fluidly connected to the inlet of the first fluid passageway of the first apparatus in the series. As such, the high temperature water 34 may flow through the plurality of third fluid passageways of each apparatus in the series before being recirculated as a coolant through the first fluid passageway of each apparatus in the series. Recirculating the high temperature water 34 as a coolant may be advantageous in embodiments where the step of providing 40 high temperature water 34 from the body of water 33 to the primary apparatus 41 comprises heating water from the body of water 33 to provide the high temperature water 34. The recirculation may help to reduce the pumping requirements of the low temperature water 35 as a reduced volume of low temperature water 34 may be used.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A method for performing a primary and a secondary process using thermal energy of a body of water comprising a dissolved mineral, the method comprising:
providing high temperature water from the body of water and low temperature water from the body of water to a primary apparatus, wherein the high temperature water is at a first temperature which is higher than a second temperature of the low temperature water;
performing a primary process in the primary apparatus, wherein the primary process comprises distilling the high temperature water by membrane distillation to extract freshwater vapour from the high temperature water, wherein either the temperature difference between the high and low temperature water provides a temperature gradient to drive the membrane distillation or the low temperature water is used to condense freshwater vapour;
removing the low temperature water from the primary apparatus and performing a secondary process using the low temperature water, wherein the secondary process comprises using the low temperature water in an air conditioning system;
wherein the step of distilling the high temperature water by membrane distillation comprises providing a membrane distillation apparatus comprising:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which freshwater vapour is passable such that, during use, a permeate of freshwater vapour is separable from a fluid that is within one of the at least one second fluid passageway and the plurality of third fluid passageways; and
distilling the high temperature water using the membrane distillation apparatus.

2. A method according to claim 1, wherein the secondary process comprises providing the low temperature water to a heat exchanger for cooling the air conditioning system.

3. A method according to claim 1, wherein the secondary process comprises using the high temperature water in the air conditioning system.

4. A method according to claim 1, comprising removing the high temperature water from the primary apparatus and using the high temperature water in a tertiary process, wherein the tertiary process comprises aquaculture or cosmetics production.

5.-10. (canceled)

11. A method according to claim 1, comprising removing the freshwater from the primary apparatus.

12. A method according to claim 1, wherein the low temperature water has a temperature from 4 to 25° C. and/or wherein the high temperature water has a temperature from 10 to 80° C.

13. (canceled)

14. A method according to claim 1, wherein the step of distilling the high temperature water comprises:
feeding the high temperature water through the plurality of third fluid passageways;
extracting the freshwater vapour from the at least one second fluid passageway; and
feeding the low temperature water through the first fluid passageway.

15. A method according to claim 1, wherein the step of distilling the high temperature water comprises:
feeding the high temperature water through the at least one second fluid passageway;
feeding a freshwater coolant having a lower temperature than the high temperature water through the plurality of third fluid passageways; and
extracting the freshwater vapour and freshwater coolant from the plurality of third fluid passageways;
wherein the freshwater coolant is cooled by the low temperature water via a heat exchanger.

16. (canceled)

17. An apparatus for performing a primary and a secondary process using thermal energy of a body of water comprising a dissolved mineral, the apparatus comprising:
a primary apparatus configured to receive high temperature water from the body of water and low temperature water from the body of water and perform a primary process, the primary apparatus comprising a membrane distillation apparatus for distilling the high temperature water to provide freshwater vapour, wherein the high temperature water has a first temperature which is higher than a second temperature of the lower temperature water and the primary apparatus is configured such that either the temperature difference between the high and low temperature water provides a temperature gradient to drive the membrane distillation or the low temperature water is used to condense freshwater vapour; and
means for removing the low temperature water from the membrane distillation apparatus and for conveying the low temperature water to a secondary apparatus for performing a secondary process, wherein the secondary apparatus is an air conditioning system configured to be cooled by the low temperature water;
wherein the membrane distillation apparatus comprises:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which freshwater vapour is passable such that, during use, a permeate of freshwater vapour is separable from a fluid that is within one of the at least one second fluid passageway and the plurality of third fluid passageways.

18. An apparatus according to claim 17, wherein the air conditioning system comprises a heat exchanger configured to receive the low temperature water.

19. An apparatus according to claim 17, comprising means for removing the high temperature water from the primary apparatus and one of means for returning the high temperature water to the body of water, or means for conveying the high temperature water to a tertiary apparatus for a tertiary process, or comprising means for removing the high temperature water from the primary apparatus and conveying the high temperature water to the secondary apparatus, wherein the air conditioning system is configured to use the high temperature water.

20. (canceled)

21. An apparatus for performing a primary and secondary processes using thermal energy of a body of water comprising a dissolved mineral, the apparatus comprising:
a primary apparatus configured to receive high temperature water from the body of water and low temperature water from the body of water and perform a primary process, the primary apparatus comprising a membrane distillation apparatus for distilling the high temperature water to provide freshwater vapour, wherein the high temperature water has a first temperature which is higher than the a second temperature of the lower temperature water and the primary apparatus is configured such that either the temperature difference between the high and low temperature water provides a temperature gradient to drive the membrane distillation or the low temperature water is used to condense freshwater vapour;
means for removing the low temperature water from the membrane distillation apparatus and means for using the low temperature water in a secondary process of carbon sequestering.

22. An apparatus according to claim 21, comprising means for releasing the low temperature water at or below the surface of the body of water for carbon sequestering, optionally comprising means for fertilising the low temperature water prior to releasing the low temperature water, or optionally comprising means for fertilising water at the surface of the body of water.

23.-24. (canceled)

25. An apparatus according to claim 21, comprising means for removing the high temperature water from the primary apparatus, means for mixing the low temperature and high temperature water and using said mixture for carbon sequestering, and means for fertilising the mixture prior to releasing the mixture at or below the surface of the body of water.

26. An apparatus according to claim 17, comprising means for removing the freshwater from the primary apparatus, or comprising a potting material configured to fixedly position the plurality of hollow fibre membranes within the at least one inner conduit.

27. An apparatus according to claim 21, wherein the membrane distillation apparatus comprises:
an outer conduit;
at least one inner conduit disposed within the outer conduit; and
a plurality of hollow fibre membranes disposed within the at least one inner conduit;
wherein a first fluid passageway is provided between the outer conduit and the at least one inner conduit; at least one second fluid passageway is provided between the at least one inner conduit and the plurality of hollow fibre membranes; and a plurality of third fluid passageways are provided within the plurality of hollow fibre membranes;
wherein each of the plurality of the hollow fibre membranes comprises a hydrophobic material through which freshwater vapour is passable such that, during use, a permeate of freshwater vapour is separable from a fluid that is within one of the at least one second fluid passageway and the plurality of third fluid passageways, or wherein the membrane distillation apparatus comprises:
a membrane comprising a hydrophobic material through the freshwater vapour is passable,
the apparatus is configured to receive the high temperature water at a first side of the membrane;
the apparatus comprises a heat exchanger on a second side of the membrane, wherein the heat exchanger is configured to receive the low temperature water.

28. An apparatus according to claim 17, wherein the at least one inner conduit comprises a plurality of inner conduits, or wherein the outer conduit and/or the inner conduit comprises an impermeable material, or wherein the at least one the inner conduit comprises a thermally conductive material.

29. An apparatus according to claim 27, comprising a potting material configured to fixedly position the plurality of hollow fibre membranes within the at least one inner conduit.

30. An apparatus according to claim 27, wherein the at least one inner conduit comprises a plurality of inner conduits, or wherein the outer conduit and/or the inner conduit comprises an impermeable material, or wherein the at least one the inner conduit comprises a thermally conductive material.

31. (canceled)

32. (canceled)

33. An apparatus according to claim 21, comprising means for removing the freshwater from the primary apparatus.
